(19) United States
(12) Patent Application Publication
(10) Pub. No.: US 2019/0230460 A1
(43) Pub. Date: Jul. 25, 2019

(54) METHOD AND APPARATUS FOR CREATING A THREE-DIMENSIONAL SCENARIO

(71) Applicant: INSTITUTO POLITÉCNICO DE LEIRIA, Leiria (PT)

(72) Inventors: João DA SILVA PEREIRA, Carvide (PT); Nuno Miguel LOURENÇO ALMEIDA, Marinha Grande (PT)

(21) Appl. No.: 16/313,059

(22) PCT Filed: Jun. 21, 2017
(86) PCT No.: PCT/IB2017/053707

§ 371 Date: Dec. 24, 2018

(30) Foreign Application Priority Data
Jun. 23, 2016 (PT) 109485

(51) Int. Cl. H04S 7/00; G06F 3/01; G06T 7/55

(52) U.S. Cl. CPC H04S 7/302; G06F 3/011; G06T 7/55; G06T 2207/10028; G06T 2207/10004; G06T 2207/10048; G06T 2207/10132

(57) ABSTRACT

The present invention is in the field of electronic equipment for virtual reality. It is an object of the present invention a method to create a three-dimensional scenario comprising: a) corresponding a distance to sound emission means (3)—distance to a virtual sound source—to a sound with at least one frequency, in a unique correspondence between a distance to a virtual sound source and a sound; and b) emitting said sound by means of sound emission means (3). By using the relation between distance and frequency, the method provides that a user determines—without using vision—the existence of a spatial point with respect to him, as well as a measure of the distance to him. In one embodiment, it is possible to distribute n virtual sound sources, each having its own associated frequency or frequencies, in n planes (1) frontal to a user. This invention also comprises a corresponding apparatus.

### FIELD OF THE INVENTION

The present invention is in the field of electronic equipment for virtual reality, having the present invention a direct utilization in the interaction with the surrounding space by persons with visual difficulties or lack of three-dimensional perception of a space without illumination.

### BACKGROUND OF THE INVENTION

The present invention has closer background in suitable virtual reality equipment for individuals suffering from visual difficulties.

Patent application with publication number EP 2 839 238 describes a two camera system suitable for capturing a pattern created from a source of light that is reflected in an object. The images captured by each camera are overlapped in order to create a three-dimensional model of a detected object.

IEEE Spectrum magazine's paper “Sight for Sore Ears” discloses a system called vOICe, which includes a device that works by converting images from a camera into complex sound images, which are then transmitted to the user via headphones. The system described can be considered as the closest prior art of the present invention, having numerous limitations that the present invention now solves.

More specifically, the system described in said paper just converts one image acquired by a single camera into a sound, indicating the position of a pixel in the image and the color, in grayscale, of said pixel. It is therefore an extremely limited solution, with very limited utility for a user with visual difficulties who wants to recognize and move himself in a surrounding space.

The object of the present invention now provides not only a solution to this problem but, as it is a more capable solution, it includes various advantageous embodiments as a result of the improved capabilities of this invention.

### SUMMARY OF THE INVENTION

It is thus object of the present invention a method to create a three-dimensional scenario comprising the following steps:

a) corresponding a value representing a distance to sound emission means (3)—called distance to a virtual sound source—to a sound with at least one frequency, in a unique correspondence between a distance to a virtual sound source and a sound;

b) emitting said sound by means of sound emission means (3).

The present invention thus provides, through the relationship between distance and frequency, that a user determine—without using vision—the existence of a spatial point with respect to him, as well as a measure of the distance to him. This method simulates the location of objects in a space, whether or not these objects are real.

In an advantageous embodiment of the method of the present invention, for a set of n virtual sound sources, the distance to a virtual sound source is inversely proportional to any frequency of emitted sound. This scheme allows a user not only to identify the distance to a certain point in the surrounding space, but also to recognize the distance of a point in relation to other points in the surrounding space, thus creating a mental conception of said space.

The method here described can be implemented for three-dimensional scenarios created computationally for virtual reality purposes, but mainly—as has already been repeatedly mentioned—for the purpose of recognition and sound presentation of a real surrounding scenario.

Thus, in another advantageous embodiment of the method of the present invention, which can be combined with any other of the described embodiments, it comprises a step for obtaining a three-dimensional scenario previously to step a), which consists in the acquisition of a real three-dimensional scenario.

Among other steps, the method of obtaining a three-dimensional scenario comprises the estimation of the distance to at least one point of a detected object (2), which in turn comprises the following steps:
intersection of a plane (1) frontal to the scanning means (4) of the surrounding space with at least one detected three-dimensional object (2); and
associating a finite number of virtual sound sources to this plane.

This method further allows sectioning the surrounding space, namely the space frontal to the scanning means (4) and therefore frontal to a user, wherein each plan contains a finite number of virtual sound sources. Thus, it is possible to distribute n virtual sound sources, each one having its own associated frequency or frequencies, in n planes (1) frontal to a user.

In this regard, and in an advantageous embodiment of the method of the present invention, which can be combined with any other of the foregoing, the sound emission is carried out in such a way that each emission instant corresponds to a frontal plane (1) with a finite number of virtual sound sources, sequentially in time and in the distance from the frontal plane (1) to the scanning means (4).

Thus, this is a simply and clearly perceivable way for a user to have a conception of the surrounding space (1) without using the vision, through the association of virtual sound sources in frontal planes (1) to which corresponds a physical quantity—its distance from sound emission means (3) which will be solidary with a user—representing the space. The emission of sounds corresponding to virtual sound sources grouped in a plane further away from the scanning means (4) will take place before the emission of sounds from a nearer plane. Thus, the user perceives the shape of the objects based on the sequential sectioned planes, which may contain a plurality of virtual sound sources at different distances from each other.

In another advantageous embodiment of the method of the present invention, which can be combined with any other of the foregoing, the sound emission means (3) consist of at least two sound emitters, wherein each of the sound emitters is arranged in such a way that a user identifies the relative position of said sound emitter from him, and is configured in such a way that each emitter emits a sound from a virtual sound source according to the relative position of said sound source with respect to the user.

Such embodiment guarantees a further level of perception of the surrounding space by a user, as it enables the user to identify whether a virtual sound source is in a certain position with respect to him, according to the sound emitters that emit sound at a certain instant.

It is also part of the present invention an apparatus to create a three-dimensional scenario comprising sound emission means (3) configured in order to, for a value representing a distance to a user—called distance to a virtual sound source —, emit a sound with at least one frequency, wherein said sound is a unique sound corresponding to said virtual sound source.

This apparatus embodies, in a physical object, the advantages of the already described method, allowing a user to determine—without using the vision—the existence of a spatial point with respect to him.

Preferentially, this apparatus is configured to implement the above method, in the different levels of the described detail, and in its different embodiments.

In an advantageous embodiment of the apparatus of the present invention, the sound emission means (3) comprises at least three sound emitters, wherein each one of the three sound emitters is arranged in such a way that a user identifies the relative position of said emitter with respect to him.

Said embodiment materializes the already described advantages for the method of the present invention, by adding a level of space perception to the user.

### DESCRIPTION OF THE FIGURES

The present set of Figs. relates to specific embodiments of the present invention, and thus it is not intended to limit its scope but just to better illustrate these embodiments.

FIG. 1—Representation of an object and its frontal cross-section planes, where R represents the center distance from the plane to a point and B represents the angle. Three pairs of loudspeakers (3) are present in the X-axis together with the pair of ultrasonic type scanning means (4) and a pair of scanning means (4) with cameras (5). The apparatus of the invention is represented here by two cubes which are located on the X-axis and symmetrically centered with respect to the origin (0, 0, 0). The actual shape of this apparatus is similar to a pair of headphones containing two pairs of 3D scanning means (4) (operating through ultrasound and images) and three pairs of loudspeakers (3). The 3D-object to be detected by sound is represented by a rectangular shape and its frontal cross-section planes (1) are parallel to the plane XZ. One of the points of this object is positioned in the coordinates (x_{P}, y_{P}, z_{P}).

FIG. 2—Representation of 1 to N frontal cross-section planes (1) of an object and of the different points present in each one of the planes. The points will be used to simulate the positioning of a virtual sound source. Planes of a rectangular object with N frontal cross-sections parallel to the plan XZ of FIG. 1 are presented.

FIG. 3—Representation of the distance between one of the points of a cross-section plane and several loudspeakers (3)—the sound emission means (3). Distances D1, D2, . . . , D6 between a point (of a virtual sound source) and 6 loudspeakers (3) are presented. For each point P, the Euclidean distance to each loudspeaker (3) (Right Back (RB), Right Up (RU), Right Down (RD), Left Back (LB), Left Up (LU), Left Down (LD)) is calculated in a total of six distances per point:

D1=\sqrt{(xₚ−x_{RB})²+(yₚ−y_{RB})²+(zₚ−z_{RB})²}

D2=\sqrt{(xₚ−x_{RU})²+(yₚ−y_{RU})²+(zₚ−z_{RU})²}

D3=\sqrt{(xₚ−x_{RD})²+(yₚ−y_{RD})²+(zₚ−z_{RD})²}

D4=\sqrt{(xₚ−x_{LB})²+(yₚ−y_{LB})²+(zₚ−z_{LB})²}

D5=\sqrt{(xₚ−x_{LU})²+(yₚ−y_{LU})²+(zₚ−z_{LU})²}

D6=\sqrt{(xₚ−x_{LD})²+(yₚ−y_{LD})²+(zₚ−z_{LD})²}

These calculations are used to simulate the positioning of a virtual sound source whose signal must propagate till it reaches each one of the six loudspeakers (3), using an ideal model of sound propagation depending on the distance of each one of the receivers.

FIG. 4—Representative scheme of an apparatus according to the present invention, comprising loudspeakers (3), camera (5) and ultrasonic radars (4).

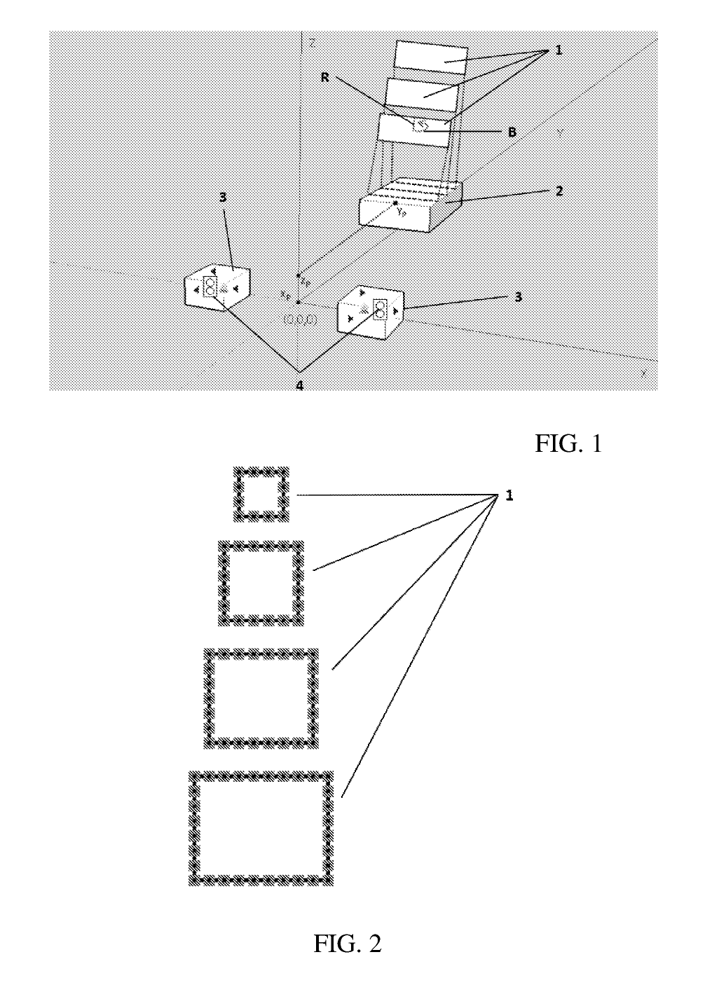

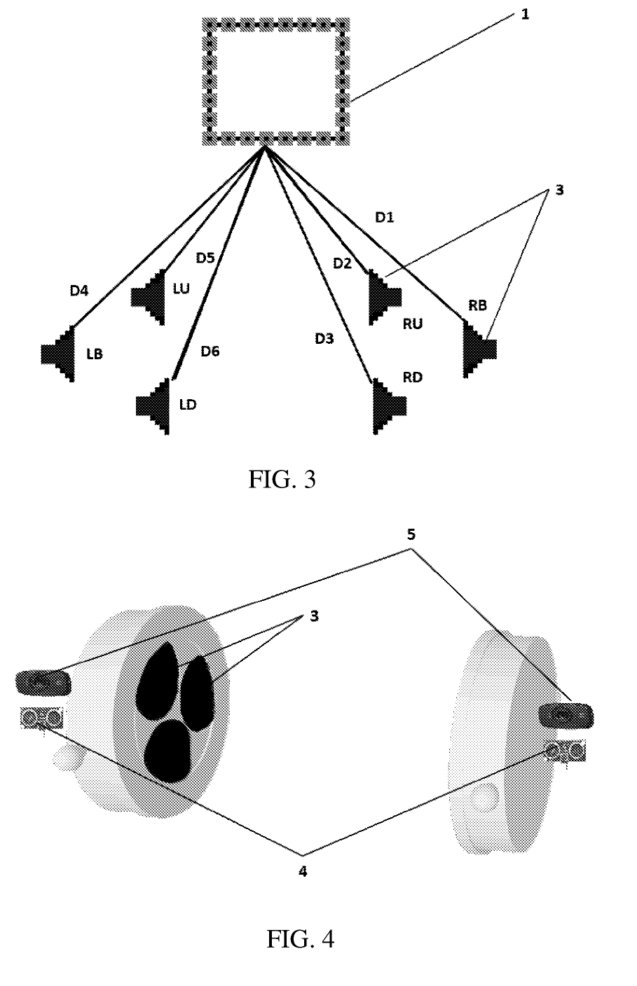

### DETAILED DESCRIPTION OF THE INVENTION

The main advantageous embodiments of the object of the present invention are described in the section SUMMARY OF THE INVENTION, being described hereinafter the features deriving from such advantageous embodiments.

In a preferred embodiment of the method of the present invention, which can be combined with any other of the foregoing, the emission of n sounds corresponding to n virtual sound sources is periodically carried out. Such embodiment allows a user to repeatedly recognize the surrounding space through the repetitive sound emission corresponding to the virtual sound sources representing a surrounding space. In addition, this makes it possible to update the sounds representing the space, for example as a consequence of the user movement.

In another embodiment of the method of the present invention, which can be combined with any other of the foregoing, the acquisition of a real three-dimensional scenario comprises the following steps:
scanning a space surrounding a user by means of scanning means (4);
detection of objects potentially present in the surrounding space;
estimation of the distance to at least one point of an object;
classification of the distance estimated in the previous step as a distance to a virtual sound source.

Thus, for a real scenario, a distance of a detected object (2) to a point is measured and a virtual sound source having at least one associated frequency is associated to it. This occurs by scanning the surrounding space based on suitable means, detection of objects that may be present in that space, and estimation of the distance to at least one point of the object. The more points are used to represent the surrounding space, the more complex and complete this representation will be.

In another embodiment of the method of the present invention, which can be combined with any other of the foregoing, the scanning means (4) are at least two, wherein the detection of objects potentially present in the surrounding space comprises calculating the average of the signals obtained from the at least two scanning means (4).

This enables a better detection of objects by using a pair of scanning means (4). For estimation of only one object, the average of the estimated objects is calculated.

In another embodiment of the method of the present invention, the scanning means (4) are ultrasonic and/or optical, wherein said average is calculated for all estimated objects by means of the different scanning means (4).

In another embodiment of the method of the present invention, which can be combined with any other of the foregoing, any emitted frequency is in the audible range for a human being.

In another embodiment of the method of the present invention, which can be combined with any other of the foregoing, a sound is emitted if a change in one of said frontal planes (1) is detected.

This enables the user to perceive more clearly the changes in the surrounding space.

In a specific embodiment of the apparatus of the present invention, which can be combined with any other of the foregoing, it comprises scanning means (4), preferably configured in order to implement the described method, in any of its embodiments.

In a specific embodiment of the one described just above, the scanning means (4) are ultrasonic and/or optical.

The apparatus of the present invention also comprises at least one controller—including computational means—for data processing, interface and control of any of the remaining elements.

In a specific embodiment of the one described just above, the sound emission means (3) consist of six loudspeakers (3) grouped three by three, and the scanning means (4) consist of a pair of ultrasound probes and a pair of cameras (5) sensitive to visible and infrared radiation.

### EMBODIMENTS

Embodiments of the apparatus of the present invention are described below.

This apparatus has an external frame in the form of a pair of audio headphones. Inside this frame are contained a pair of ultrasonic 3D scanning means (4), a pair of 3D scanning means (4) with cameras (5) sensitive to visible and infrared radiation, and three pairs of loudspeakers (3).

It may be used ultrasonic sonar or radar-type three-dimensional scanning means (4), or scanning means with cameras (5) having a certain sensitivity to light, and they may determine the deformation of a pattern on the object surface based on different orientations/positions of the cameras (5).

The various types of three-dimensional scanning means (4) are used in pairs in order to reinforce the precision of depth calculation of an object or scenario. The pair of ultrasonic means may be constituted by ultrasound emitters/receivers placed on a movable platform that allows periodically scanning the scenario from top to bottom, from left to right, and thus to create a 3D-image thereof.

An embodiment of the method of the present invention is described below.

Using the 3D scanning means (4) it is possible to create three-dimensional objects in the space where a person is. The surface of this object is virtually covered by several virtual sound sources. For each virtual sound source placed on the object surface, the distance between the user and said source is calculated. These distances are calculated in order to simulate the locations of the various sound sources from the three-dimensional space and reaching the three pairs of loudspeakers (3), considering that the sound signals propagate without distortion and without reflections in a homogenous transmission medium, without obstacles.

This 3D-spatial object or scenario is decomposed into several parallel frontal layers that are periodically and sequentially accessed/used, wherein the periodic scan is carried out from the furthest layer to the nearest. Different audible frequencies are used to determine each one of the frontal planes (1), used at each moment. Each one of these layers is represented in a 2D plane, where the curves through which pass the cross-sections of the frontal planes (1) in the 3D-object are located. The curves of each frontal plane (1) are represented by a limited number of points that are used to simulate the origin of a sound source in a three-dimensional space. The virtual location points of the virtual sound sources of each plane are represented by 2D polar coordinates (radius=R and angle=B) centered with a horizontal line crossing the center of the three-dimensional object of the space and the center of the three pairs of loudspeakers (3). The virtual location points of the sound sources have equal audible frequencies whenever the radius R are equal, although the angles B might be different in the [0°, 360°] range. The virtual points with larger radius R are represented by low audible frequencies and the points with smaller radius are represented by higher audible frequencies. The user of the invention can estimate the object contour based on hearing an audible frequency proportional to the radius R in each plane. This process is periodically and quickly repeated in each frontal plane (1) with different frequencies.

The three pairs of loudspeakers (3) emit sound based on the simulation of the several virtual sound sources scattered in a three-dimensional space which is periodically scanned from backward to forward, and from the ends to the center, in each individual frontal plane (1).

The three pairs of loudspeakers (3) are located close to the user's hearing system in a way that he has the sensation of capturing/hearing a surround sound proportional to the shape of the 3D-object or the three-dimensional scenario. Each one of the pairs of loudspeakers (3) is conveniently located to provide the user with a sensation of the correct sound origin (up, down and back, spaced a few centimeters from each ear). That is, this sound can be personalized with an orientation/direction: “it comes from above or from below”, “it comes from the right side or from the left side” and “it comes from the front or from the back”. Periodic scanning of all the frontal planes (1) provides the user with distinct sounds for each type of three-dimensional shape.

After the various 3D-images from the various scanning means (4) have been acquired, the average of the various 3D-images is calculated. After this process, the 3D-object is decomposed into several frontal planes (1) where the various lines of the cross-sections are drawn.

As will be apparent to one person skilled in the art, the present invention should not be limited to the embodiments described herein, and a number of changes which remain within the scope of the present invention are possible.

Obviously, the preferred embodiments presented above can be combined, in the different possible forms, avoiding repeating all such combinations here.

1. A method to create a three-dimensional scenario characterized in that it comprises the following steps:
a) corresponding a value representing a distance to sound emission means (3)—called distance to a virtual sound source—to a sound with at least one frequency, in a unique correspondence between a distance to a virtual sound source and a sound;
b) emitting said sound by means of sound emission means (3).

2. Method according to claim 1, characterized in that, for a set of n virtual sound sources, the distance to a virtual sound source is inversely proportional to any frequency of emitted sound.

3. Method according to claim 1, characterized in that the emission of n sounds corresponding to n virtual sound sources is periodically carried out.

4. Method according to claim 1, characterized in that the sound emission means (3) are at least three sound emitters, wherein each one of the three sound emitters is arranged in such a way that a user identifies the relative position of said sound emitter (3) from him, and are configured in such a way that each emitter emits a sound from a virtual sound source according to the relative position of said sound source with respect to the user.

5. Method according to claim 1, characterized in that it comprises a step for obtaining a three-dimensional scenario previously to step a), which consists in the acquisition of a real three-dimensional scenario.

6. Method according to claim 5, characterized in that the acquisition of a real three-dimensional scenario comprises the following steps:
scanning a space surrounding a user by means of scanning means (4);
detection of objects potentially present in the surrounding space;
estimation of the distance to at least one point of an object;
classification of the distance estimated in the previous step as a distance to a virtual sound source.

7. Method according to claim 6, characterized in that it comprises a step for estimating the distance to at least one point of an object, which in turn comprises the following steps:
intersection of a plane (1) frontal to the scanning means (4), with at least one detected three-dimensional object (2);
associating a finite number of virtual sound sources to this plane.

8. Method according to claim 2, characterized in that the sound emission is carried out in such a way that each emission instant corresponds to a frontal plane (1) with a finite number of virtual sound sources, sequentially in time and in the distance from the frontal plane (1) to the scanning means (4).

9. Method according to claim 5, characterized in that the ultrasonic and/or optical scanning means (4) are at least two, wherein the detection of objects potentially present in the surrounding space comprises calculating the average of the signals obtained from the at least two scanning means (4).

10. Method according to claim 1, characterized in that any emitted frequency is in the audible range for a human being.

11. Method according to claim 7, characterized in that a sound is emitted if a change in one of said frontal planes (1) is detected.

12. Apparatus to create a three-dimensional scenario comprising sound emission means (3), characterized in that the sound emission means (3) are configured to, for a value representing a distance to the sound emission means (3)—called a distance to a virtual sound source —, emit a sound with at least one frequency, wherein said sound is a unique sound corresponding to said virtual sound source, preferably configured in order to implement the method of claim 1.

13. Apparatus according to claim 12, characterized in that the sound emission means (3) consist of at least three sound emitters, wherein each of the three sound emitters is arranged in such a way that a user identifies the relative position of said emitter with respect to him.

14. Apparatus according to claim 12, characterized in that it comprises scanning means (4), preferably configured to implement the method of any of the claims 1-11, with said scanning means (4) being preferably ultrasonic and/or optical.

15. Apparatus according to claim 14, characterized in that the sound emission means (3) consist of six loudspeakers (3), grouped three by three, the scanning means (4) consisting of a pair of ultrasound probes and a pair of cameras (5) sensitive to visible and infrared radiation.
